(19) United States
(12) Patent Application Publication
(10) Pub. No.: US 2026/0212850 A1
(43) Pub. Date: Jul. 23, 2026

(54) INFORMATION PROCESSING SYSTEM, INFORMATION PROCESSING METHOD, NON-TRANSITORY COMPUTER-READABLE MEDIUM STORING PROGRAM, AND INFORMATION PROCESSING DEVICE

(71) Applicant: Yamaha Corporation, Hamamatsu (JP)

(72) Inventor: Hiromu SATO, Hamamatsu (JP)

(21) Appl. No.: 19/564,485

(22) Filed: Mar. 12, 2026

Related U.S. Application Data
(63) Continuation of application No. PCT/JP2024/029515, filed on Aug. 20, 2024.

(30) Foreign Application Priority Data
Sep. 19, 2023 (JP) 2023-150681

(51) Int. Cl. G10H 1/36

(52) U.S. Cl. CPC G10H 1/36

(57) ABSTRACT

An information processing system includes at least one processor configured to execute a request information acquisition unit, a proposal unit, and a reception unit. The request information acquisition unit is configured to acquire request information of a user relating to a musical instrument. The proposal unit is configured to select one or more candidate instruments corresponding to the request information, and propose, to the user, the one or more candidate instruments that have been selected, together with performance sound data of each of the one or more candidate instruments. The reception unit is configured to receive a selection of a desired instrument to be provided from among the one or more candidate instruments, and the selection is input by the user.

### CROSS-REFERENCE TO RELATED APPLICATIONS

This application is a continuation application of International Application No. PCT/JP2024/029515, filed on Aug. 20, 2024, which claims priority to Japanese Patent Application No. 2023-150681 filed in Japan on Sep. 19, 2023. The entire disclosures of International Application No. PCT/JP2024/029515 and Japanese Patent Application No. 2023-150681 are hereby incorporated herein by reference.

### BACKGROUND

### Field of the Invention

This disclosure generally relates to an information processing system, an information processing method, a non-transitory computer-readable medium storing a program, and an information processing device that can be applied to a musical instrument provision service.

### Background Information

Japanese Laid Open Patent Application No. 2020-194363 discloses a technique aimed at improving user satisfaction in a service that provides products through subscriptions.

Japanese Laid-Open Patent Publication No. 2022-154835 discloses a technique that allows a user to easily specify a tile carpet that the user wishes to receive on a subscription basis, and aims to provide an appropriate tile carpet that satisfies the user's wishes at an appropriate time.

Japanese Laid-Open Patent Publication No. 2002-251532 discloses a technique aimed at selling custom-made products that are optimal for a user's skin condition or state of health, when selling cosmetics and health foods online via a network.

### SUMMARY

Improving user satisfaction is also an important issue in a service that provides musical instruments.

In consideration of the circumstances described above, one object of this disclosure is to provide an information processing system, an information processing method, a transitory computer-readable medium storing a program, and an information processing device that can realize a musical instrument provision service that achieves high user satisfaction.

In order to achieve the object described above, an information processing system according to this disclosure includes at least one processor configured to execute a request information acquisition unit, a proposal unit, and a reception unit.

The request information acquisition unit is configured to acquire request information of a user relating to a musical instrument.

The proposal unit is configured to select one or more candidate instruments corresponding to the request information, and propose, to the user, the one or more candidate instruments that have been selected, together with performance sound data of each of the one or more candidate instruments.

The reception unit is configured to receive a selection of a desired instrument to be provided from among the one or more candidate instruments, and the selection is input by the user.

An information processing method according to this disclosure is executed by a computer system, and the method includes acquiring request information of a user relating to a musical instrument.

One or more candidate instruments corresponding to the request information are selected, and the one or more candidate instruments that have been selected are proposed to the user, together with performance sound data of each of the one or more candidate instruments.

A selection, input by the user, of a desired instrument to be provided from among the one or more candidate instruments is received.

A non-transitory computer-readable medium storing a program according to one embodiment of this disclosure causes a computer system to execute a process including acquiring request information of a user relating to a musical instrument, selecting one or more candidate instruments corresponding to the request information, and proposing, to the user, the one or more candidate instruments that have been selected, together with performance sound data of each of the one or more candidate instruments, and receiving a selection of a desired instrument to be provided from among the one or more candidate instruments, the selection being input by the user.

An information processing device according to this disclosure includes at least one processor configured to execute a request information acquisition unit, a proposal unit, and a reception unit.

### BRIEF DESCRIPTION OF THE DRAWINGS

FIG. 1 is a schematic diagram showing a configuration example of an instrument selection support system according to a first embodiment.

FIG. 2 is a flowchart showing an example of a basic operation of a user-side terminal and a support server in the instrument selection support system.

FIG. 3 is a schematic diagram showing one example of a questionnaire for a user to input request information.

FIG. 4 is a schematic diagram showing one example of a screen presenting one or more candidate instruments displayed on the user-side terminal.

FIG. 5 is a schematic diagram showing one example of parts constituting a snare drum in a second embodiment.

FIG. 6 is a schematic diagram showing a configuration example of an instrument selection support system according to a third embodiment.

FIG. 7 is a schematic diagram showing a configuration example of an instrument selection support system according to a fourth embodiment.

FIG. 8 is a schematic diagram showing a configuration example of an instrument selection support system according to a fifth embodiment.

FIG. 9 is a block diagram showing an example of a hardware configuration of a computer that can be used as a user-side terminal, a support server, and a subscription management server.

FIG. 10 is a schematic diagram showing a configuration example of an instrument selection support system according to one of the other embodiments.

### DETAILED DESCRIPTION OF EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

An embodiment according to this disclosure will be described below with reference to the drawings.

### First Embodiment

### Instrument Selection Support System

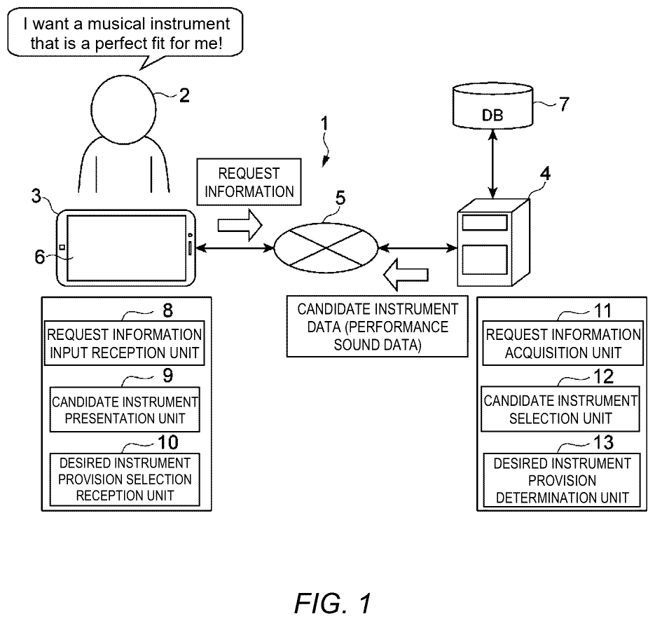

FIG. 1 is a schematic diagram showing a configuration example of an instrument selection support system according to a first embodiment of this disclosure. The instrument selection support system 1 is able to support a user 2 using the present system in selecting a musical instrument that suits the preference of the user 2.

A “musical instrument that suits the preference” of the user 2 typically is a musical instrument whose performance sounds suit the preference of the user 2, but is not limited thereto. The instrument selection support system 1 can be constructed to accommodate various “preferences” of the user 2, such as an instrument frequently used in a favorite music genre of the user 2, an instrument used by a favorite musician of the user 2, an instrument whose appearances suit a preference of the user 2, an instrument with conditions relating to the production, such as the date of manufacture, material, etc., that suit a preference of the user 2, and the like.

In this description, a snare drum (refer to FIG. 4) whose performance sounds suit the preference of the user 2 will be described as an example of a “musical instrument that suits the preference” of the user 2. Of course, the instrument selection support system 1 can be applied to any other musical instrument.

As shown in FIG. 1, in the present embodiment, the instrument selection support system (a musical instrument selection support system) 1 includes a user-side terminal 3 and a support server 4.

The user-side terminal 3 and the support server 4 are connected so as to be communicate with each other via a network 5. The network 5 is constructed by the Internet, a wide area communication network, or the like. In addition, any wide area network (WAN), local area network (LAN), etc., can be used, and the protocol for constructing the network 5 is not limited.

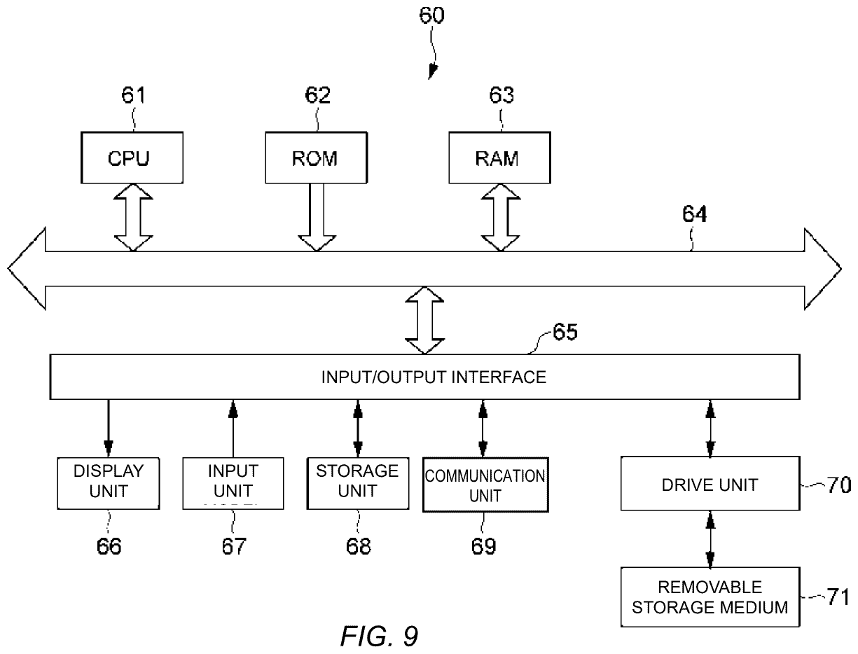

The user-side terminal 3 and the support server 4 each include hardware required by a computer, for example, one or more processors such as CPU (Central Processing Unit), GPU (Graphics Processing Unit), and DSP (Digital Signal Processor), memory (computer memory) such as RAM (Random Access Memory) and ROM (Read Only Memory), and a storage device such as HDD (Hard Disk Drive) (refer to FIG. 9). The one or more processors load a program into the RAM and executes the program according to the present technique stored in the storage unit or the memory, thereby executing the information processing method according to the present technique (instrument selection support method).

In the example shown in FIG. 1, a smartphone equipped with a touch panel 6 is used as the user-side terminal 3. The touch panel 6 functions as a display unit (display) and an input unit (a user operable input). The touch panel 6 displays various image information, such as icons, text, GUI (graphical user interface), and captured images. In addition, VR virtual reality) display for displaying VR (virtual reality) objects and AR (augmented reality) display for displaying AR (augmented reality) objects superimposed on real objects are also possible.

The user 2 can carry out various touch operations and text input operations, etc., with respect to a GUI or icons, etc., displayed on the touch panel 6. It is thereby possible for the user 2 to input various information.

Various devices, such as a camera (imaging function), a microphone (voice input function), a speaker (voice output function), a GPS (Global Positioning System) (position detection function), and an IMU (inertial measurement unit) sensor (movement detection function), are installed in a smartphone used as the user-side terminal 3.

In the present disclosure, images include both still images and moving images (video). In the present embodiment, the imaging function of the user-side terminal 3 is able to capture, as the captured image, moving images including sound information.

The computer used as the user-side terminal 3 is not limited to a smartphone, and any configuration can be employed. For example, a tablet terminal, a head mounded display (HMD) such as AR (augmented reality) or VR (virtual reality) glasses, a PC (Personal Computer), or the like can be used.

The server device 4 is configured to realize the instrument selection support system 1, and any computer such as a PC can be used.

As shown in FIG. 1, in the present embodiment, a database (DB) 7 that can be accessed by the support server 4 is constructed. The DB 7 functions as a storage unit and stores various information relating to the instrument-related support system 1. The DB 7 can be constructed in a storage device, etc., provided in the support server 4, or be constructed in a storage device configured outside of the support server 4.

In the present embodiment, a musical instrument DB is constructed inside the DB 7. The musical instrument DB includes various musical instrument data that can be proposed to the user 2. For example, the musical instrument data include ID (identification), instrument identification information which allows the user 2 to identify each musical instrument, data on the performance sounds (performance sound data) of each musical instrument, and the like. The instrument identification information includes one or more images of each musical instrument, text information such as the model and product number of each musical instrument, and the like.

The performance sound data of each musical instrument are recording data that record performance sounds when the musical instrument is actually played. Of course, the recording data can be appropriately processed so that the user 2 can more clearly hear the performance sound data. Moreover, sound data that are audibly almost identical to performance sounds when a musical instrument is actually played can be synthesized and created electronically.

Any other information relating to musical instruments can be stored as the musical instrument data.

### Functional Configuration of Each Device

As shown in FIG. 1, in the present embodiment, the processor of the user-side terminal 3 executes a prescribed program to configure, as functional blocks, a request information input reception unit 8, a candidate instrument presentation unit 9, and a desired instrument provision selection reception unit 10. Of course, dedicated hardware such as an integrated circuit (IC) can be used to realize functional blocks.

The request information input reception unit 8 receives input of request information relating to a musical instrument from the user 2. The “request information” includes any request relating to the musical instrument desired by the user 2. For example, an image of a musical instrument desired by the user 2, performance sound data desired by the user 2, or the like, can be input as the request information.

In the present embodiment, the input of information to the user-side terminal 3 by the user 2 and the output (presentation) of information from the user-side terminal 3 to the user 2, are not limited to the input and output of information via the touch panel 6; input of information by voice input, input and output of information through dialogue between the user 2 and the user-side terminal 3, and the like are also possible.

The request information input reception unit 8 executes various processes for realizing the input of request information by the user 2. For example, various processes are executed such as controlling the operations of the touch panel 6, the speaker (sound output device), the microphone (sound input device), etc., generation of a GUI for inputting the request information, generation of sound data that are output from the speaker, management of the request information input via the touch panel 6 or microphone, and the like.

The candidate instrument presentation unit 9 presents, to the user 2, one or more candidate instruments selected by the support server 4. The one or more candidate instruments are presented to the user 2 together with performance sound data of each candidate instrument.

The candidate instrument presentation unit 9 executes various processes for realizing the presentation of one or more candidate instruments to the user 2. For example, various processes are executed such as controlling the operations of the touch panel 6, the speaker (sound output device), the microphone (sound input device), etc., generation of a presentation screen that displays a list of images, etc., of the candidate instruments, output of the performance sound data of each candidate instrument, and the like.

The desired instrument provision selection reception unit 10 receives, from one or more candidate instruments, a selection of an instrument that the user 2 wishes to be provided with, input by the user 2.

The desired instrument provision selection reception unit 10 executes various processes for receiving a selection of the instrument that the user 2 wishes to be provided with. For example, various processes are executed such as controlling the operations of the touch panel 6, the speaker (sound output device), the microphone (sound input device), and the like.

In addition, as shown in FIG. 1, in the present embodiment, the processor of the support server 4 executes a prescribed program to configure, as functional blocks, a request information acquisition unit 11, a candidate instrument selection unit 12, and a desired instrument provision determination unit 13. Of course, dedicated hardware such as an integrated circuit (IC) can be used to realize the functional blocks.

The request information acquisition unit 11 acquires request information of the user 2.

In the present disclosure, acquisition of information includes not only receiving the information from another device but also the device itself executing an analysis process, an extraction process, an estimation process, or the like, to generate the information. That is, in the present embodiment, acquisition of request information by the request information acquisition unit 11 includes both a case in which request information transmitted from the user-side terminal 3 is received and a case in which an analysis process, etc., is executed on the received request information to generate a different type of request information.

The candidate instrument selection unit 12 selects one or more candidate instruments corresponding to the acquired request information. The candidate instrument selection unit 12 selects one or more candidate instruments that are closest to the request of the user 2, and the musical instrument data of each of the one or more candidate instruments that have been selected are read from the musical instrument DB in the DB 7. As described above, each of the one or more pieces of musical instrument data includes instrument identification information (image of the musical instrument, text information such as the model, and the like) and performance sound data.

The desired instrument provision determination unit 13 determines the desired instrument to be provided based on selection information of the desired instrument to be provided received by the user-side terminal 3. Information on the desired instrument to be provided that has been determined is stored and managed in the DB 7.

Any technique (algorithm, etc.) can be used in order to execute processes of the user-side terminal 3 such as reception of the input of request information, presentation of candidate instruments, and reception of selection of a desired instrument to be provided, as well as processes of the support server 4 such as acquisition of request information, selection of candidate instruments, and determination of the desired instrument to be provided.

For example, any machine learning algorithm using a deep neural network (DNN), a recurrent neural network (RNN), a convolutional neural network (CNN) or the like can be used. For example, artificial intelligence (AI) that carries out deep learning can be used to execute each process with high precision.

For example, a trained model that has undergone machine learning for inputting request information (for example, performance sound data, performance video, etc.) received from the user-side terminal 3 and outputting a different type of request information (model of the musical instrument, characteristics of the performance sounds, etc.) can be constructed and used in the request information acquisition unit 11 of the support server 4.

In addition, a trained model that has undergone machine learning for inputting request information and outputting candidate instruments can be constructed and used in the candidate instrument selection unit 12. By using such learning models, it becomes possible to select candidate instruments that sufficiently correspond to the request information with high accuracy.

For example, the error backpropagation method is used as the training method for the learning model. The error backpropagation method is a commonly-used training method for training neural networks. A neural network is a model that imitates neural circuits of the human brain, and has a layered structure including three types of layers: an input layer, an intermediate layer (hidden layer), and an output layer.

Neural networks with numerous intermediate layers are specifically referred to as deep neural networks, and the deep learning technique used for training such networks is known as a modeling approach that can learn complex patterns hidden in large amounts of data. The error backpropagation method is one such training method, and is commonly used for training CNNs used in image and video recognition.

In addition, neurochips/neuromorphic chips incorporating the neural network concept can be used as the hardware structure for realizing such machine learning.

The algorithm for training the learning model is not limited, and any machine learning algorithm can be used. Examples of machine learning algorithms include supervised learning, unsupervised learning, semi-supervised learning, reinforcement learning, inverse reinforcement learning, active learning, and transfer learning. In addition, a machine learning model such as a hidden Markov model (HMM) or a support vector machine (SVM) can be used.

A training block (training unit) for training the learning model can be configured in the user-side terminal 3 or/and the support server 4. Alternatively, the training block (training unit) can be configured in a computer different from the user-side terminal 3 and the support server 4, and the trained learning model after training has been executed can be installed in the user-side terminal 3 or/and the support server 4. In addition, the specific configurations of the learning model and the training block (training unit) for training the learning model are not limited.

Note that the machine learning algorithm can be applied to any process within the present disclosure. That is, a process using machine learning can be executed on any process described within the present disclosure.

In addition, the method for extracting various information such as request information from a captured image of the musical instrument is not limited, and any technique (algorithm) can be used. For example, any image recognition technique can be used, such as projective transformation, edge detection, and matching processing using a model image of an object. In addition, skeleton estimation (bone estimation) and similar techniques can be used. Additionally, an existing externally-constructed library having functions such as image processing and machine learning can be used.

Any machine learning algorithm can be used to extract information from captured images. For example, semantic segmentation can be executed on image information, thereby making it possible to determine the type of object for each pixel in the image.

The method for extracting various information such as request information from sound data such as performance sound data of a musical instrument is also not limited, and any technique can be used.

In the present embodiment, the instrument selection support system 1 corresponds to one embodiment of the information processing system according to this disclosure. In addition, in the present embodiment, the request information input reception unit 8 of the user-side terminal 3 and the request information acquisition unit 11 of the support server 4 realize the request information acquisition unit according to this disclosure, which acquires information on a user's requests relating to musical instruments.

In addition, the candidate instrument presentation unit 9 of the user-side terminal 3 and the candidate instrument selection unit 12 of the support server 4 realize the proposal unit according to this disclosure, which selects one or more candidate instruments corresponding to the acquired request information, and proposes, to the user, the one or more candidate instruments that have been selected, together with performance sound data of each of the one or more candidate instruments.

In addition, the desired instrument provision selection reception unit 10 of the user-side terminal 3 and the desired instrument provision determination unit 13 of the support server 4 realize the reception unit according to this disclosure, which receives a selection of the desired instrument to be provided from among the one or more candidate instruments, input by the user.

In addition, the user-side terminal 3 and the support server 4 constituting the instrument selection support system 1 each functions as one embodiment of the information processing device including the request information acquisition unit, the proposal unit, and the reception unit according to this disclosure.

A computer equipped with both the functions of the user-side terminal 3 and the functions of the support server 4 can be configured as one embodiment of the information processing device according to this disclosure. For example, the functions of the support server 4 can be provided in the user-side terminal 3. In this case, the user-side terminal 3 realizes an instrument selection support system, which is the information processing system according to this disclosure.

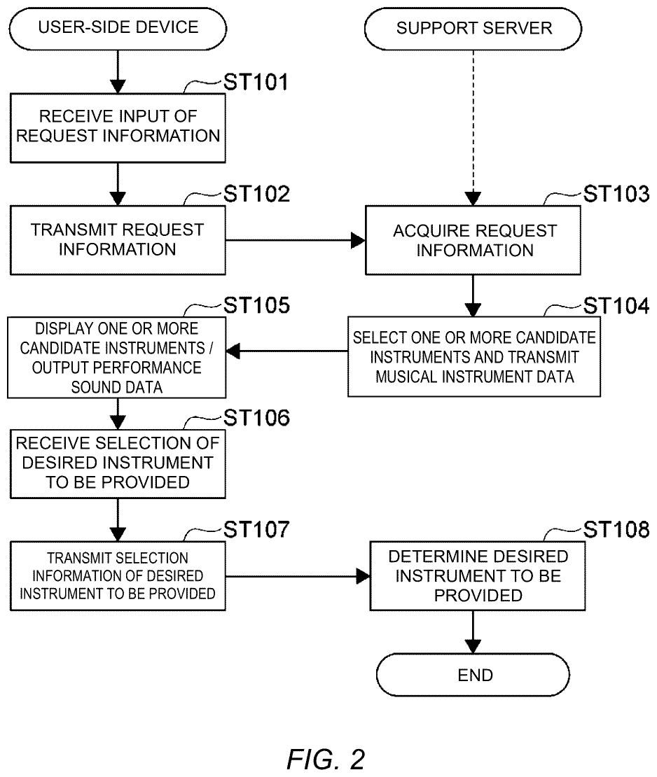

FIG. 2 is a flowchart showing an example of a basic operation of the user-side terminal 3 and the support server 4 in the instrument selection support system 1.

The request information input reception unit 8 of the user-side terminal 3 receives input of request information from the user 2 (step ST101).

For example, the user 2 downloads, onto the user-side terminal 3, an application (application program) for using the instrument selection support system 1. For example, the user 2 inputs information such as an ID and a password to create an account for using the instrument selection support system 1. Of course, creation of an account need not be mandatory.

The user 2 starts the application for using the instrument selection support system 1. Then, the user selects a request information input mode and inputs request information relating to the musical instrument that the user desires via an input screen (GUI) for inputting request information.

The specific format for inputting the request information is not limited, and any format can be employed, such as text input, voice input, and questionnaire input (input of information by a questionnaire). In addition, the method, GUI, etc., by which the user 2 inputs the request information is not limited, and any can be freely designed.

As shown in FIG. 1, the request information that has been received is transmitted to the support server 4 via the network 5 (step ST102).

The request information acquisition unit 11 of the support server 4 acquires the request information (step ST103). In the present embodiment, reception of the request information transmitted from the user-side terminal 3 and generation of a different type of request information based on the request information that has been received are executed. Of course, it suffices if only one of either reception of request information or generation of reception information is executed.

The candidate instrument selection unit 12 of the support server 4 selects one or more candidate instruments corresponding to the request information. Then, from the musical instrument DB, the musical instrument data (candidate instrument data) of each of the selected one or more candidate instruments are read from the musical instrument DB and transmitted to the user-side terminal 3 via the network 5 (step ST104). The candidate instrument data include instrument identification information (which, in the present embodiment, includes one or more images of the candidate instruments) and performance sound data.

The candidate instrument presentation unit 9 of the user-side terminal 3 displays, on the touch panel 9, the one or more images of the one or more candidate instruments selected by the support server 4. In addition, the candidate instrument presentation unit 9 outputs the performance sound of each candidate instrument via the speaker (step ST105).

The desired instrument provision selection reception unit 10 of the user-side terminal 3 receives a selection of an instrument that the user 2 wishes to be provided with from among the one or more candidate instruments, input by the user 2 (step ST106). In addition, the desired instrument provision selection reception unit 10 transmits, to the support server 4, selection information indicating the desired instrument to be provided that has been selected (step ST107).

The desired instrument provision determination unit 13 of the support server 4 determines the desired instrument to be provided based on the selection information transmitted from the user-side terminal 3 (step ST108).

### Input of Request Information by the User

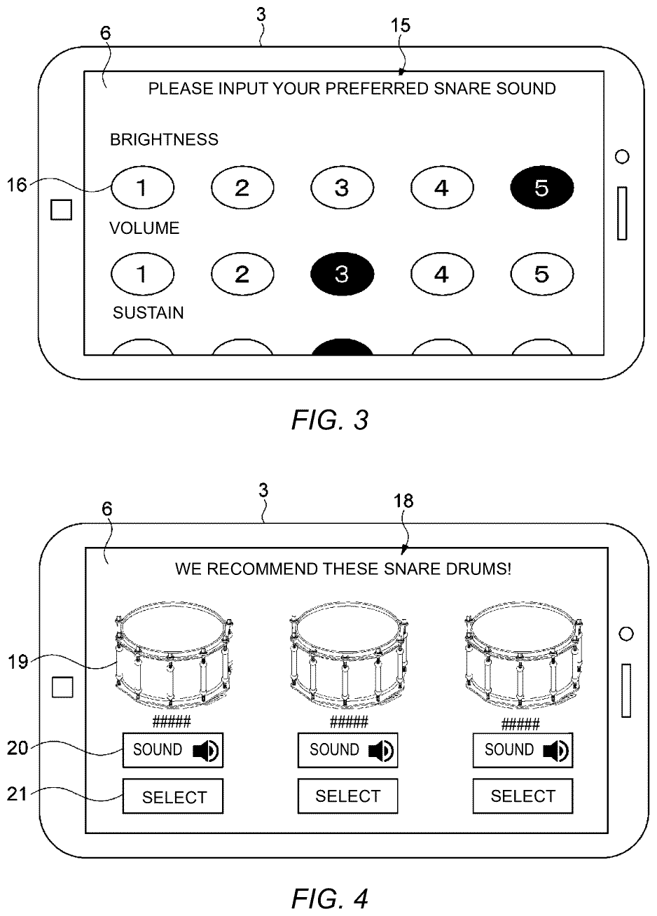

FIG. 3 is a schematic diagram showing one example of a questionnaire into which the user 2 inputs request information.

The request information that can be input by the user 2 is not limited, and can include any request relating to the musical instrument desired by the user 2. A request relating to characteristics of the performance sound of the musical instrument desired by the user 2 is an example of request information. For example, it is possible to input request information of the user 2 for each of the following evaluation items (characteristics) relating to the characteristics of the performance sound (snare sound) of a snare drum.

It is possible to input request information relating to any evaluation item expressed as a characteristic of the performance sound, such as “brightness,” “volume,” “sustain,” “attack,” “response,” “thickness,” and “delicateness.”

In the example shown in FIG. 3, a questionnaire 15 is displayed with a heading such as “Please enter your preferred snare sound.” The questionnaire 15 is provided with 5-point evaluation buttons 16 from 1 to 5 for each of the evaluation items relating the characteristics of the snare sound. The user 2 selects, as appropriate, one of the evaluation buttons 16 from 1 to 5 for each evaluation item, thereby making is possible to input, as the request information, information on the snare sound that the user 2 desires.

For example, the user 2 can input, as the request information, a numerical value for each item, such as “brightness=5,” “volume=3,” “sustain=3,” “attack=3,” “response =4,” “thickness=4,” and “delicateness=1.” In the example shown in FIG. 3, a prescribed touch operation can be carried out, such as a scroll operation, to display evaluation items other than “brightness,” “volume,” and “sustain” on the touch panel 6, and input numerical values as request information.

When selecting from the evaluation buttons 16 shown in FIG. 13, a sample sound of the snare sound corresponding to the numerical values of the currently-selected evaluation items can be output to the user 2.

For example, when constructing the instrument selection support system 1, evaluation criteria for snare sounds are established in advance. For example, an evaluation criterion to serve as reference is established for each of the evaluation items such as “brightness,” “volume,” “sustain,” “attack,” “response,” “thickness,” and “delicateness.” The method of establishing the evaluation criteria is not limited; the evaluation criteria can be freely established based on various parameters relating to sound, such as frequency band, attack curve, and decay curve.

Sample sound data corresponding to the numerical value of each evaluation item are created based on the established evaluation criteria. The sample sound data can be created based on performance sounds of an actual snare drum or can be created electronically.

Sample sounds corresponding to the numerical value of each evaluation item input by the user 2 can be output, thereby making it possible for the user 2 to ascertain the snare sounds corresponding to the numerical value of each evaluation item that the user 2 input. Then, the numerical value of each evaluation item can be changed, as appropriate, thereby making it possible for the user 2 to further refine the desired snare sound.

In addition, it becomes possible for the user 2 who does not have much knowledge about each of the evaluation items of “brightness,” “volume,” “sustain,” “attack,” “response,” “thickness,” “delicateness,” etc., to intuitively arrive at a snare sound that the user 2 likes, thereby exhibiting high usability. Of course, an explanation of each evaluation item can be displayed as appropriate. For example, sample sounds can be output so that it is possible to compare between two sounds, such as “this is a bright sound, and this is a dark sound.”

In addition, for the evaluation items of “brightness,” “volume,” “sustain,” “attack,” “response,” “thickness,” “delicateness,” etc., it can be configured such that the user 2 can manipulate these parameters in the application to create the desired snare sound.

For example, the user 2 selects a snare sound mixing mode. Then, an operation button such as a fader is displayed for each evaluation item (evaluation parameter). A sample of the snare sound is output in accordance with the fader operation of each evaluation item (evaluation parameter). For example, the user 2 carries out a mixing operation by operating the fader, such as slightly increasing the “brightness” and slightly lowering the “sustain.”

In such a snare sound mixing mode, the user 2 can carry out mixing while actually listening to sample sounds, thereby making it possible to arrive at the desired snare sound. In addition, even if the user 2 is not familiar with expressions unique to drums (evaluation items such as “sustain”), the user 2 can easily find the preferred snare drum.

Other examples of the request information that the user 2 can input include the following information.
Favorite genre. “rock,” “pop,” “jazz,” “heavy metal,” “hard rock,” “funk,” “ska,” “chanson,” “blues,” “enka,” etc.
Favorite musician. “name of musician,” “name of band,” “name of orchestra,” etc.
Appearance of musical instrument. “color,” “shape,” etc.
Information relating to manufacture of musical instrument. “date of manufacture,” “material,” etc.
Any other information relating to musical instruments can be input as the request information.

For example, the request information input reception unit 8 generates and outputs various questionnaires for inputting the request information. The user 2 inputs answers to the questionnaires. The response information with respect to the questionnaires is input as the request information and received by the request information input reception unit 8.

Alternatively, input of information by voice input, input of information through dialogue between the user 2 and the user-side terminal 3, and the like can be executed. Alternatively, performance sound data desired by the user 2 can be input as a request relating to characteristics of the performance sound. In addition, an image of a musical instrument capturing the appearance of the musical instrument desired by the user 2, data on a song played by a favorite musician, a video capturing a performance by a favorite musician, and the like, can be input as the request information.

Various questions relating to the request can be output to the user 2 from the user-side terminal 3. For example, the content of questions that a store clerk would ask a customer at an actual musical instrument store can be output from the user-side terminal 3. For example, questions that musical instrument store clerks often ask customers can be searched for and included in the questionnaire items, thereby making it possible to use, in the instrument selection support system 1, questions that are effective in knowing what the user 2 wants.

### Selection of Candidate Instruments

Assume that the request information acquisition unit 11 of the support server 4 has acquired, as the request information, a numerical value for each evaluation item of a snare sound, such as “brightness,” “volume,” “sustain,” “attack,” “response,” “thickness,” and “delicateness.” The candidate instrument selection unit 12 of the support server 4 selects, as one or more candidate instruments, snare drums that can produce performance sounds corresponding to the numerical values of the evaluation items.

In the present embodiment, for each of a plurality of snare drums that can be proposed, an evaluation value for each evaluation item such as “brightness,” “volume,” “sustain,” “attack,” “response,” “thickness,” and “delicateness” is set based on an evaluation criterion established in advance. That is, an evaluation value of each evaluation item that can be input as the request information is set for each snare drum. These evaluation values are stored in the musical instrument DB as musical instrument data.

The candidate instrument selection unit 12 compares the numerical value of each evaluation item acquired as the request information with the evaluation value of each evaluation item stored as musical instrument data, and selects, as a candidate instrument, a snare drum for which evaluation values close to the numerical values of the request information are set.

A method that can be used to select a candidate instrument is, for example, the least squares method. That is, the squares of the differences between the numerical values of the evaluation items (request information) and the preset evaluation values are all summed. A snare drum with a small summed value is selected as a candidate instrument. By using the least squares method, candidate instruments corresponding to the request information can be selected using a simple calculation. Of course, the method that can be used to select a candidate instrument is not limited to the least squares method, and any method (algorithm) can be used.

Of the evaluation items of “brightness,” “volume,” “sustain,” “attack,” “response,” “thickness,” and “delicateness,” one or more evaluation items that are considered particularly important can be selected as the request information of the user 2. For example, it can be configured such that the user 2 can place importance on the evaluation item of “brightness” and input a request for a snare drum with a similar “brightness,” or place importance on the evaluation item of “attack” and input a request for a snare drum with a similar “attack.”

When there is an input of an evaluation item considered important, a candidate instrument is selected so that the evaluation item considered important is prioritized. For example, when the above-mentioned least squares method is used, weighting (coefficient) is added as appropriate to the evaluation item considered important to carry out a calculation. For example, for an evaluation item considered important, weighting (coefficient) corresponding to the degree of importance is added to the square of the difference between the numerical value (request information) that has been input and a preset evaluation value, and integration is carried out. As a result, snare drums having evaluation values that are close to the numerical values (request information) of the evaluation items considered important are preferentially selected as the candidate instruments. It can be configured such that the user 2 can input the degree of importance of each evaluation item, and weighting (coefficient) corresponding to the degree of importance is added. As a result, it becomes possible to select the candidate instruments that meet the request with higher accuracy, and to improve the satisfaction of the user 2.

In addition, the numerical value of each evaluation item of the snare sound, and other request information such as information on favorite genres and favorite musicians, etc., can be used in a comprehensive manner to select the candidate instruments corresponding to such evaluation information. For example, a trained learning model that has undergone machine learning for inputting various types of request information and outputting corresponding musical instruments can be constructed and used.

Sound data, video, etc., that are input by the user 2 as the request information are analyzed and the analysis results are further generated as the request information. It is also possible to select a candidate instrument based on the further generated request information.

For example, sound data of a snare sound are analyzed, and an evaluation value (evaluation value on a 5-point scale) is set for each evaluation item such as “brightness,” “volume,” “sustain,” “attack,” “response,” “thickness,” and “delicateness” based on evaluation criteria established in advance. Then, candidate instruments are selected using the least squares method, or the like, based on the evaluation value of each item that has been set. Of course, the selection of the candidate instruments is not limited thereto. For example, components, etc., of a snare sound are extracted from a desired musical sound input by the user 2 by an analysis process such as sound source separation, and a snare drum that outputs sounds similar to the components is selected as a candidate instrument. Such processing is also possible.

A recommendation level with respect to the user 2 can be set for the one or more candidate instruments that have been selected. For example, higher recommendation levels are set for candidate instruments that are closer to the request information. For example, regarding each evaluation item relating to a snare sound, higher recommendation levels are set for candidate instruments having smaller values of the sum-of-squares result of the least squares method. Of course, the recommendation level can be set based on the matching degree with other request information, such as genre and musician.

In addition, information relating to candidate instruments corresponding to the request information can be proposed to the user 2. For example, with respect to request information relating to a bass drum, information on the configuration of the musical instrument, such as the optimum diameter and depth, can be proposed.

### Proposal of Candidate Instruments

FIG. 4 is a schematic diagram showing one example of a screen presenting the one or more candidate instruments displayed on the user-side terminal 3.

In the example shown in FIG. 4, a presentation screen 18 is displayed, showing a heading such as “We recommend these snare drums!” In this presentation screen 18, images of selected candidate instruments 19 and the model names (“#####”) are displayed side by side. In addition, a sound button 20 and a select button 21 are provided for each of the candidate instruments 19.

The user 2 selects the sound button 20 provided for each of the candidate instruments 19. As a result, a snare sound, which is the performance sound of the candidate instrument 19, is output to the user 2. The user 2 can select the desired instrument to be provided while checking the performance sound of each of the candidate instruments 19.

The candidate instruments 19 displayed on the presentation screen 18 are selected based on the request information input by the user 2. Accordingly, all of the candidate instruments 19 are snare drums that are close to the preference of the user 2. The user 2 is able to further select from a plurality of snare drums that suit the preference of the user 2, a snare drum that the user 2 will treasure and have a close relationship with going forward.

When a musical instrument that seems like a perfect fit is found, the user 2 selects the select button 21 provided to each of the candidate instruments 19. As a result, the desired instrument provision selection reception unit 10 of the user-side terminal 3 receives input of a selection of the desired instrument to be provided, and the selection information is transmitted to the support server 4. Then, the desired instrument provision determination unit 13 of the support server 4 determines the desired instrument to be provided.

The one or more candidate instruments are proposed with the recommendation level reflected. The one or more of the candidate instruments 19 can be proposed in a format (manner) in which the recommendation level set by the candidate instrument selection unit 12 is reflected. For example, in the presentation screen 18 shown in FIG. 4, the candidate instruments 19 can be arranged and displayed in descending order of the recommendation level. Of course, information indicating the recommendation level can be displayed for each of the candidate instruments 19. For example, the recommendation level can be displayed as a numerical value, or text such as “This snare drum is our top recommendation!” can be displayed.

A confirmation button for confirming the detailed information of each of the candidate instruments 19 can be provided on the presentation screen 18 shown in FIG. 4. When the confirmation button is selected, for example, the screen switches to a detail display screen that displays detailed information of the candidate instrument 19. Then, the detail display screen displays detailed information of the candidate instrument 19, such as the manufacture date, the genres in which the snare drum is often used, information on one or more musicians who use the snare drum, and the like.

The evaluation value of each evaluation item of the snare sound can also be displayed as detailed information of the candidate instrument 19. As a result, it becomes possible for the user 2 to compare the numerical value of each evaluation item that the user 2 input as the request information with the evaluation value of each evaluation item set for the candidate instrument, enabling the user 2 to explore in more detail the musical instrument that is best fitting.

In addition, a change/update button for each candidate instrument can be provided on the presentation screen 18 shown in FIG. 4. When the change/update button for a candidate instrument is selected, the candidate instrument selection unit 12 selects another candidate instrument. The musical instrument data (including performance sound data) of the selected candidate instrument is transmitted to the user-side terminal 3 again and displayed on the candidate instrument presentation screen 18. In this manner, it can be configured so that the candidate instrument 19 can be changed/updated. As a result, the user 2 can more widely search for a musical instrument that is a perfect fit.

In addition, a request information re-enter button can be provided on the presentation screen 18 shown in FIG. 4. When a request information re-enter button is selected, the questionnaire 15 shown in FIG. 3 is displayed again, for example. At that time, the display occurs in a state in which the numerical value input most recently by the user 2 is reflected as is.

For example, the user 2 re-enters the numerical value of each evaluation item while considering matters such whether the user 2 wants more “brightness” and whether the user 2 thinks the “sustain” could be reduced. The numerical value of each evaluation item that has been re-entered is transmitted to the support server 4 and one or more candidate instruments are selected again. The musical instrument data (including performance sound data) of the selected candidate instrument is transmitted to the user-side terminal 3 again and displayed on the candidate instrument presentation screen 18. In this manner, it can be configured so that the one or more candidate instruments can be updated by re-entering the evaluation items. As a result, the user 2 can more thoroughly search for a musical instrument that is a perfect fit.

As described above, in the instrument selection support system 1 according to the present embodiment, one or more candidate instruments are selected based on the request information of the user 2 relating to musical instruments, which are proposed to the user 2 together with performance sound data. The user 2 can thereby select the desired instrument to be provided while checking the performance sounds of the one or more candidate instruments. As a result, it becomes possible to realize a musical instrument provision service with high degree of user satisfaction.

When the user 2 purchases a musical instrument, there can be cases in which it is difficult for the user 2 to select a musical instrument that is a perfect fit. In particular, when purchasing a musical instrument for the first time (first purchase), it is often difficult to decide which musical instrument to select.

The following are possible reasons why it may be difficult to select a musical instrument.

The user is not confident in their judgment (the user wants someone's advice).

The user lacks a sound reference and thus cannot distinguish between musical instruments.

Opportunities to test play are limited (may be zero) so that it is not possible to make sufficient comparisons.

Unfamiliar terms are used in descriptions of musical instruments, making visualization difficult (brightness, warmth, crispness, response, etc.).

The user cannot verbalize their preferences.

For example, there may be cases where characteristics and appeal of each musical instrument are not fully conveyed even when looking at a catalog of musical instruments. As a result, doubts and anxiety remain as to whether a particular snare drum is really the best fit.

In addition, when browsing the Internet, the user may find articles like “Top 3 Recommended Snare Drums.” However, the user cannot tell whether the snare drums recommended therein are the best fit for the user.

In the instrument selection support system 1 according to the present embodiment, candidate instruments corresponding to the request information of the user 2 can be proposed to the user 2. That is, various requests such as preferences, desired sound characteristics, and favorite genres, can be obtained from each of the users 2, and candidate instruments that match or are close to the requests can be fed back and proposed.

As a result, it becomes possible to propose one or more optimal musical instruments that match each of the users 2, thereby achieving highly accurate personalization. Compared to cases in which a musical instrument is selected simply based on a catalog or articles like “Top 3 Recommended Snare Drums,” the accuracy of personalization becomes extremely high.

Because one or more recommended musical instruments are proposed with sufficient evidence with respect to the request, the user 2 can select and purchase a musical instrument that best fits the user 2 with peace of mind and confidence. The confidence can also have a positive effect on performance activities after the purchase of the musical instrument.

Of course, it is also possible to propose not only one or more musical instruments that the user 2 already knows but also one or more musical instruments, etc., that the user 2 does not know. The user 2 can experience discovery such as “I didn't know such an instrument existed”, which makes it possible for the user to further explore musical instruments that better suit their preference.

By implementing the instrument selection support system 1 according to the present embodiment, it becomes possible to realize a musical instrument provision system with high satisfaction of the user 2 by which it is possible to have two-way communication between companies that manufacture and sell musical instruments and the users 2, rather than communication that is mostly a one-way street from companies to the users 2.

For example, when the user wants a bass drum, it may be difficult to test play various types (diameters, depth, etc.) even when visiting a musical instrument store. In the instrument selection support system 1 according to the present embodiment, it is possible to select one or more bass drums as the one or more candidate instruments corresponding to the request information while checking the performance sounds, which can provide a high level of satisfaction.

In addition, by using the instrument selection support system 1 according to the present embodiment, it is possible to check which instrument best suits the user 2 when there is a plurality of musical instruments that will be newly released. That is, it is also possible to use the instrument selection support system 1 according to the present embodiment for the purpose of finding the most suitable musical instrument for oneself from among a plurality of musical instruments. For example, when the musical instrument is expensive and is difficult to test play, it is useful to be able to find the most suitable musical instrument for oneself.

Paying attention to the point described above regarding unfamiliar terms being used in the description of musical instruments, making visualization difficult (e.g., brightness, warmth, crispness, response), the one or more candidate instruments can be proposed to the user 2 that is a beginner using onomatopoeia instead of technical terms. For example, instead of terms such as “brightness,” “volume,” “sustain,” “attack,” “response,” “thickness,” and “delicateness,” words such as “thud,” “bang,” “pop,” “tap,” “clang,” “ping,” “snap,” “pang,” “paaang,” “thwack,” “crack,” and “sizzle” can be used to describe evaluation items, describe the one or more candidate instruments, compare the candidate instruments, and the like.

### Second Embodiment

An instrument selection support system of a second embodiment according to this disclosure will be described. Hereinbelow, descriptions of parts having the same configurations and effects as those of the instrument selection support system 1 described in the above-mentioned embodiment will be omitted or simplified.

In the present embodiment, it is possible to meet the requests of the user 2 at the level of individual parts that constitute the musical instrument. That is, one or more candidate parts can be proposed together with performance sound data in accordance with request information that is input by the user 2. In this case, the performance sound data are performance sound data of musical instruments configured using one or more candidate parts to be proposed.

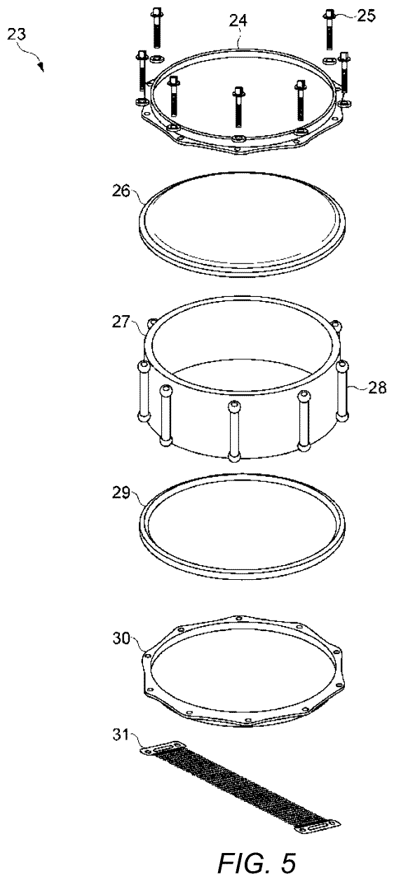

FIG. 5 is a schematic diagram showing one example of parts constituting a snare drum 23. In the example shown in FIG. 5, the following parts are illustrated.

Top hoop 24 . . . considered as one part including tension rods 25

Batter head (front head) 26

Shell (body) 27 . . . considered as one part including lugs 28 to which the tension rods 25 are attached

Snare-side head (rear head) 29

Bottom hoop 30 . . . considered as one part including tension rods (not shown)

Snare wires (wires) 31 . . . considered as one part including the snare cord and snare tape (not shown)

In the present disclosure, a musical instrument is understood to include parts that constitute the musical instrument. That is, each part constituting a musical instrument is also considered a musical instrument. In the example shown in FIG. 5, the “top hoop,” “batter head,” “shell,” “snare-side head,” “bottom hoop,” and “wires” are each considered a musical instrument. In addition, one or more candidate parts proposed to the user 2 are conceptually included in one or more candidate instruments.

It is possible to set, as appropriate, which portions are to be regarded as a single part. For example, it is possible to set the combination of the “top hoop” and the “bottom hoop” shown in FIG. 5 as a single part. It is also possible to regard a “top hoop” that does not include the tension rods 25 as a single part. It is also possible to regard a “shell” that does not include the lugs 28 as a single part. In is also possible to regard the “tension rods” and “lugs” as single parts.

The request information of the user 2 relating to a musical instrument includes request information relating to parts. In the present embodiment, one or more candidate parts can be proposed together with performance sound data based on the request information. For example, three types of shells, shell A, shell B, and shell C, can be proposed as the one or more candidate parts. At this time, performance sound data A of a snare drum configured using the shell A, performance sound data B of a snare drum configured using the shell B, and performance sound data C of a snare drum configured using the shell C are also proposed.

In addition, selection of a desired instrument to be provided includes selection of a desired part to be provided from among one or more candidate parts. For example, the user 2 checks each piece of the performance sound data A to C, and selects a desired part to be provided from among the shells A to C. In this manner, because it is possible to select a musical instrument (parts) that best suits oneself at the level of individual parts, customization that suits the user 2's needs becomes possible. As a result, it becomes possible to realize a musical instrument provision service with high degree of satisfaction of the user 2.

For example, the candidate instrument selection unit 12 shown in FIG. 1 selects one or more candidate parts. The one or more candidate parts and performance sound data are transmitted to the user-side terminal 3. The candidate instrument presentation unit 9 of the user-side terminal 3 presents, to the user 2, the one or more candidate parts and the performance sound data.

Here, a process flow that is useful when the user 2 selects a musical instrument at the level of individual parts will be described. First, as described in the first embodiment, one or more candidate instruments (snare drums) are proposed together with performance sound data based on the request information of the user 2 relating to snare drums.

For example, audio data of snare sounds desired by the user 2, link information of performance videos of artists that the user 2 likes and that are distributed through a video distribution service, etc., answers to a questionnaire regarding characteristics of snare sounds, and the like, are input as the request information. The one or more candidate instruments 19 as illustrated in FIG. 4 are presented based on the request information that has been input.

Next, the user 2 selects a reference instrument from among the one or more candidate instruments 19. The reference instrument is a musical instrument that serves as a reference for selecting a desired instrument to be provided. Accordingly, in the present embodiment, selection of the reference instrument input by the user 2 is received, the reference instrument serving as a reference for selecting a desired instrument to be provided from among the one or more candidate instruments 19. For example, a functional block (“reference instrument selection reception unit”) that receives selection of a reference instrument is newly constructed. The functional block functions as a part of the “proposal unit” according to this disclosure.

When the reference instrument is selected, the user 2 inputs request information including further requests for the reference instrument. For example, the further request information for the reference instrument is received by the request information input reception unit 8 of the user-side terminal 3. Then, the request information acquisition unit 11 of the support server 4 acquires the further request information for the reference instrument.

One or more parts constituting the reference instrument are changed based on the further request for the reference instrument and proposed to the user 2. For example, the candidate instrument selection unit 12 selects a part to be changed, which is transmitted to the user-side terminal 3 together with the performance sound data. The candidate instrument presentation unit 9 of the user-side terminal 3 presents, to the user 2, the candidate part that has been changed and the performance sound data.

At this time, the performance sound of the part before the change and the performance sound of the part after the change can be presented to the user 2 in a manner in which the performance sounds can be compared. In addition, there can be two or more candidate parts to be changed. In this case, it can be configured such that the performance sounds before change and a plurality of performance sounds corresponding to the plurality of candidate parts after the change can be compared. As a result, the user 2 is able to sufficiently consider which part is best (which of the parts is best), making it possible to find a part that is a perfect fit.

One example of the above-mentioned process flow will be described using a snare drum as an example.

Assume that a snare drum to serve as a reference instrument is selected from one or more snare drums that are the one or more candidate instruments. For example, the user 2 selects a button for inputting further requests, and the screen switches to an input screen for further requests. The input screen displays a GUI with which it is possible to input further request information relating to the characteristics of the snare sound, for example. Alternatively, it can be configured such that request information relating to other matters can be input, such as the period during which a favorite artist was active.

For example, it can be configured such that further request information can be input for each evaluation item for the snare sound described with reference to FIG. 3, and the like. Example will be described below of a further request with respect to characteristics of the snare sound that is input by the user 2, and the corresponding changes in the parts. Of course, the changes in the parts described below are merely examples and are not necessarily limiting.

“I want a little more volume”→Change the thickness of the “batter head.” For example, change to a thicker batter head.

“I want a softer sound”→Change the material and structure of the “top hoop” and “bottom hoop.” Examples of materials include aluminum, iron, and brass. With respect to these materials, the material and structure of the “top hoop” and the “bottom hoop” are changed, focusing on the hardness, weight, manufacturing method (die-casting/bending), etc. For example, when the “top hoop” and the “bottom hoop” of the reference instrument are made of aluminum, it is conceivable to change the material to brass in order to meet the further request.

“I want a more punchy sound”→Change the material of the “shell.” For example, when the shell of the reference instrument is made of maple, the material is changed to aluminum in order to meet the further request. The “punch of the sound” can take several forms; therefore, it is also effective to present a plurality of candidate changes in a manner in which the performance sounds can be listened to and compared. This presentation of a plurality of candidate changes can also be adopted for further requests other than the “punch of the sound.”

“I want the snare sound to be more assertive”→Change the “snare wires.” For example, change the snare wires to a type with a large number of strands. Alternatively, change the material of the snare wires.

“I want to change the design of the lugs”→Change to “lugs” with a different design.

“It would be better if the snare wires were more assertive”→Change the “snare wires.” For example, change the snare wires to a type with a large number of strands. Alternatively, change the material of the snare wires.

“I want a more focused sound (e.g., I want a snare sound with fewer overtones. I want a damped sound rather than an open sound)”→Change the type of the “head” to a thicker one.

“I want a brighter sound”→Change the material of the “shell” to wood.

“I want the sound to be a little more responsive”→Change the type of the “head” to a thinner one (one commonly used in jazz, etc.). Change the “snare wires.”

In addition, it is possible to change one or more parts in accordance with various requests. For example, it is possible to accommodate requests such as “the sustain should be a little longer,” “the snare sound should be a little harder,” and “I want a more open sound” by changing parts.

Advice information relating to settings such as tuning and the method of use of the candidate part can be output when proposing the one or more candidate parts. It thereby becomes advantageous when obtaining the desired performance sound, making it possible to achieve a high level of satisfaction.

There are many musical instruments that are made of a plurality of parts, such as the snare drum. In such musical instruments, combinations of parts also become numerous, and there are cases in which it is difficult for the user 2 to find the optimal combination.

In the present embodiment, the user 2 can select one or more candidate parts while checking the performance sounds. It is also possible to receive suggestions of candidate parts that correspond to further requests, so that the user 2 can sufficiently obtain the desired parts. Of course, it is also possible to receive suggestions of parts of a type hitherto unknown to the user 2, so that the user 2 can widely search for parts that suit the preference of the user 2. As a result, it becomes possible to achieve high-quality customization for each user 2.

When inputting further request information, the user 2 can be able to specify parts that the user 2 would like to change.

There are various conceivable ways by which the user 2 could acquire a desired instrument to be provided (desired parts to be provided) after the user 2 selects the desired instrument to be provided (desired parts to be provided). For example, the user 2 can visit a nearby musical instrument store, etc., and purchase the desired instrument to be provided (desired parts to be provided). Alternatively, the user 2 can purchase the desired instrument to be provided (desired parts to be provided) online via an e-commerce site, etc.

In addition, it is sufficiently conceivable for a company that manufactures and sells musical instruments to construct the present instrument selection support system 1 and provide the service to the user 2. In this case, it is possible to provide, following support for selecting a musical instrument, support for purchasing the desired instrument to be provided (desired parts to be provided) that the user 2 selected.

For example, a service can be developed that makes it possible to purchase a desired instrument to be provided (desired parts to be provided), such as ordering the desired instrument to be provided (desired parts to be provided), within the same application as the application for using the instrument selection support system 1.

### Third Embodiment

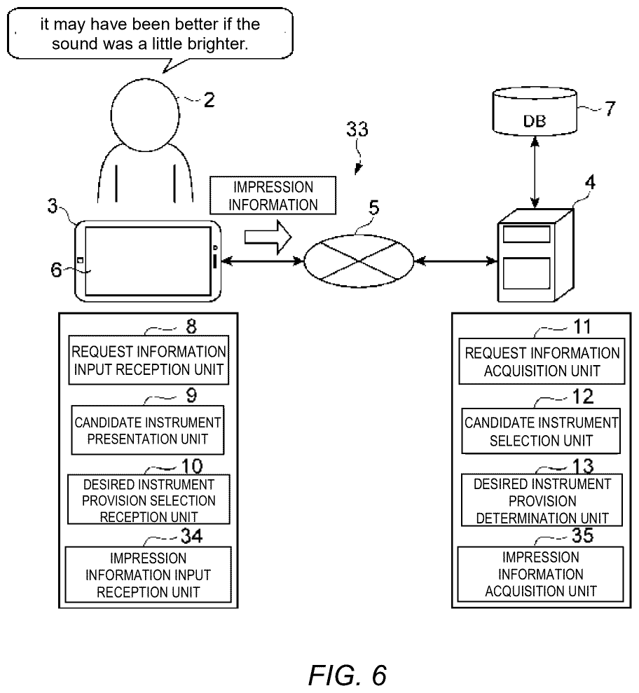

FIG. 6 is a schematic diagram showing a configuration example of an instrument selection support system according to a third embodiment of this disclosure.

In the present embodiment, the user 2 who has acquired a desired instrument to be provided can input, into the user-side terminal 3, impression of the user 2 after actually playing the desired instrument to be provided. Then, the support server 4 can acquire the impression information (hereinafter referred to as actual performance impression information) of the user 2 who has actually played the desired instrument to be provided.

In the present disclosure, the actual performance includes various forms by which the user 2 plays the desired instrument to be provided that the user 2 selected. Typically, the actual performance is when the user 2 actually plays the desired instrument to be provided in real space (real world). However, the actual performance is not limited thereto; in the present disclosure, the actual performance also includes a case in which the user 2 wearing an HMD, etc., plays the desired instrument to be provided in virtual space (virtual world).

For example, the user 2 wearing an HMD, etc., plays a virtual object of a snare drum that the user 2 selected as the desired instrument to be provided while holding actual sticks. At this time, performance sounds of the snare drum corresponding to the swinging of the arms and the striking of the sticks are output from the HMD, etc. The actual performance in the present disclosure also includes such a performance of a desired instrument to be provided in virtual space.

In a performance of a desired instrument to be provided in virtual space, when the performance sound output from the HMD, etc., is a sound based on the performance sound produced when an actual snare drum is actually played, it is considered to be the actual performance according to this disclosure, and when the sound is a performance sound generated electronically (virtually), it is considered not to be the actual performance according to this disclosure. It is also possible to implement the present technique in accordance with such criteria.

In an instrument selection support system 33 shown in FIG. 6, an impression information input reception unit 34 is configured as a functional block in the user-side terminal 3. In addition, an impression information acquisition unit 35 is configured in the support server 4. These functional blocks are configured, for example, by a processor of each device executing a prescribed program. Of course, dedicated hardware such as an integrated circuit (IC) can be used to realize the functional blocks.

The impression information input reception unit 34 receives input of actual performance impression information from the user 2. For example, an input screen (GUI) for inputting actual performance impression information is displayed in an application for using the instrument selection support system 33. Then, actual performance impression information is input via the input screen.

The specific format for inputting the actual performance impression information is not limited, and any format can be employed, such as text input, voice input, and questionnaire input (input of information by a questionnaire). In addition, the method, GUI, etc., by which the user 2 inputs the actual performance impression information, etc. is not limited, and any can be freely designed.

For example, actual performance impression information of when a snare drum is actually played can be input for each evaluation item for the snare sound described with reference to FIG. 3, etc. For example, when the user 2 thinks “it may have been better if the sound was a little brighter,” actual performance impression information is input indicating that the evaluation item of “brightness” could have been a higher numerical value. Of course, various other forms can be adopted for inputting actual performance impression information.

In addition, performance sound data of when a desired instrument to be provided is actually played or video of the performance can be input as actual performance impression information.

The impression information acquisition unit 35 of the support server 4 receives the actual performance impression information input to the user-side terminal 3. In addition, the impression information acquisition unit 35 can further generate actual performance impression information based on the actual performance impression information received from the user-side terminal 3.

In the present embodiment, the impression information input reception unit 34 of the user-side terminal 3 and the impression information acquisition unit 35 of the support server 4 realize the actual performance impression information acquisition unit according to this disclosure which acquires the user's actual performance impression information when actually playing the desired instrument to be provided.

In addition, each of the user-side terminal 3 and the support server 4 constituting the instrument selection support system 33 functions as one embodiment of an information processing device equipped with the actual performance impression information acquisition unit according to this disclosure.

The actual performance impression information can be used for various purposes. For example, in the present embodiment, reference information that serves as a reference for selecting the one or more candidate instruments (candidate parts) is updated based on the actual performance impression information.

The reference information includes evaluation criteria for each evaluation item described with reference to FIG. 3, for example. For example, in each of the evaluation items of “brightness,” “volume,” “sustain,” “attack,” “response,” “thickness,” “delicateness,” etc., evaluation criteria for defining evaluation of “1” to “5” with respect to the performance sound correspond to one embodiment of the reference information according to this disclosure.

For example, evaluation criteria for defining a 5-point scale are updated for each evaluation item based on the actual performance impression information. For example, when actual performance impression information indicating that “it may have been better if the sound was a little brighter” is acquired, it can be determined that “brightness” was insufficient. That is, it can be determined that the “brightness” according to the current evaluation criteria is a performance sound that is slightly low in “brightness” for the user 2.

Based on the determination, the evaluation criteria are updated so that, for example, performance sound that has been evaluated as having a “brightness=3” would now be evaluated as having a “brightness=2.” As a result, it becomes possible to establish evaluation criteria that are in line with the impressions of the user 2.

Statistical processing can be executed on the actual performance impression information acquired from each of the users 2, and the evaluation criteria can be updated based on the results of the statistical processing. For example, as a result of the statistical processing, when more pieces of the actual performance impression information indicating it may have been better if the sound was a little brighter” than a predetermined threshold value are obtained, the evaluation criteria for “brightness” can be updated.

In addition, as a result of the statistical processing, the magnitude of the value by which the evaluation criteria are updated can be calculated based on the distribution of the actual performance impression information. For example, when the actual performance impression information indicating “it may have been better if the sound was a little brighter” is acquired at a rate of 70%, the evaluation criteria are updated such that performance sounds that were evaluated as “brightness=3” would now be evaluated as “brightness=2.”

On the other hand, when the actual performance impression information indicating “it may have been better if the sound was a little brighter” is acquired at a rate of 95%, it can be determined that the evaluation criteria for “brightness” were too low, so that the evaluation criteria are updated such that performance sounds that were evaluated as “brightness=4” would now be evaluated as “brightness=2.” Such processing is also possible.

In addition, the reference information can be adjusted for each of the users 2. For example, assume that each of the users 2 is asked to create an account when using the instrument selection support system 33. It thereby becomes possible to construct a user DB and to manage each piece of user information for each user ID.

In such cases, it is possible to manage evaluation criteria for each user based on the actual performance impression information of each of the users 2.

For example, for a user A, the evaluation criteria established in advance are adopted as they are for each evaluation item of the snare sound. For a user B, because the actual performance impression information indicating that “it may have been better if the sound was a little brighter” was acquired, the evaluation criteria are updated such that performance sounds that were evaluated as “brightness=3” would be evaluated as “brightness=2.”

For a user C, because the actual performance impression information indicating that “I wanted a little more volume” was acquired, the evaluation criteria are updated such that performance sounds that were evaluated as “volume=3” would be evaluated as “volume=2.” Such personalization for each of the users 2 is also possible, making it possible to achieve a high level of satisfaction for each of the users 2.

Of course, the development department of a company that manufactures musical instruments could use the actual performance impression information when developing a new product. For example, it is possible to obtain information such as whether there was any deviation in the design intent of a musical instrument and what points of the musical instrument could be improved. By collecting the impressions of numerous users 2 who actually have played in various environments, it becomes possible to produce high-quality musical instruments that meet the needs of the users 2.

In this manner, it is possible to effectively use actual performance impression information collected from numerous users 2. For example, at a company that manufactures musical instruments, a prescribed evaluation criteria regarding characteristics of the performance sounds of musical instruments, such as the above-mentioned evaluation items related to snare sounds, are established in advance and stored in an evaluation criteria DB. It is possible to update and refine the evaluation criteria related to characteristics of performance sounds of each musical instrument stored in the evaluation criteria DB based on the actual performance impression information that has been collected. As a result, it becomes possible to construct an evaluation criteria DB that matches the needs of the user 2, and to realize manufacture of high-quality musical instruments.

In addition, when constructing the user DB in which user information for each of the users 2 is stored, it is possible to manage the evaluation criteria related to characteristics of performance sounds of each musical instrument for each of the users 2 as user information. For example, in the initial state, evaluation criteria established in advance by a company, etc., are stored in the user DB as each piece of user information. When each of the users 2 inputs their respective actual performance impression information, the evaluation criteria for each user is updated and refined based on the actual performance impression information. It is thereby possible to achieve high-quality personalization.

In addition, when developing and manufacturing a musical instrument, there are many cases in which the opinions of professional musicians are taken into consideration. At this time, there can be cases in which evaluation criteria such as “brightness” are established in accordance with the sensibilities of professional musicians. There can be cases in which there is a difference in sensibilities between a professional musician and a general user with respect to an evaluation item related to the characteristics of a sound, such as “brightness.”

For example, assume that a snare drum is newly launched, in which a professional musician A was involved in the development with an emphasis on “attack”. When a general user who admires the professional musician A purchases and actually plays the snare drum, there can be cases in which, due to difference in skill, etc., the user has an impression such as “I can't get the attack I wanted.”

In such cases, by collecting the actual performance impression information from general users, it is possible to establish evaluation criteria that can absorb the difference between the sensibilities of professional musicians and the perceptions of amateur musicians in each evaluation item relating to characteristics of the performance sound. For example, it becomes possible to make determinations such as when a professional musician feels that a prototype product has an “attack=5,” it corresponds to a musical instrument having an “attack=4” for an amateur musician. As a result, it becomes possible to enhance the brand power of the company that manufactures musical instruments.

### Fourth Embodiment

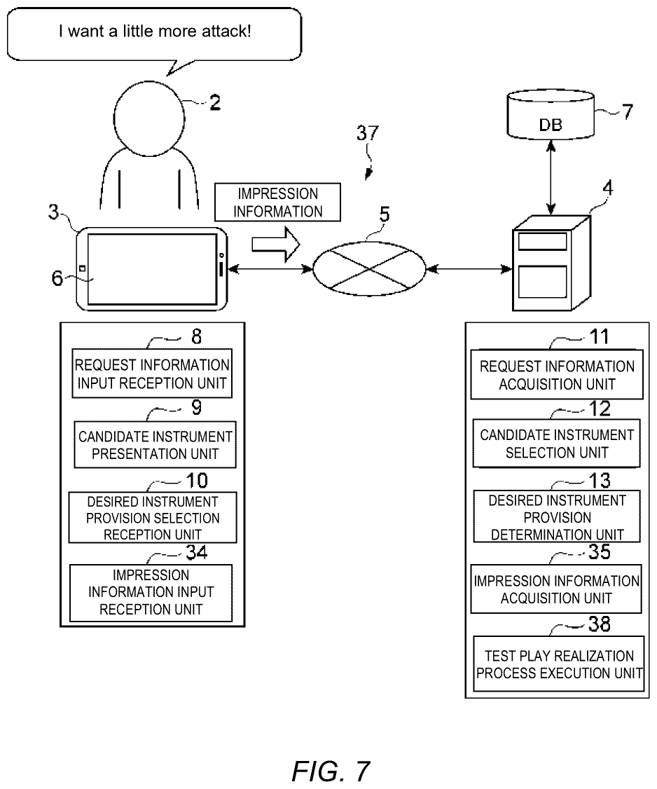

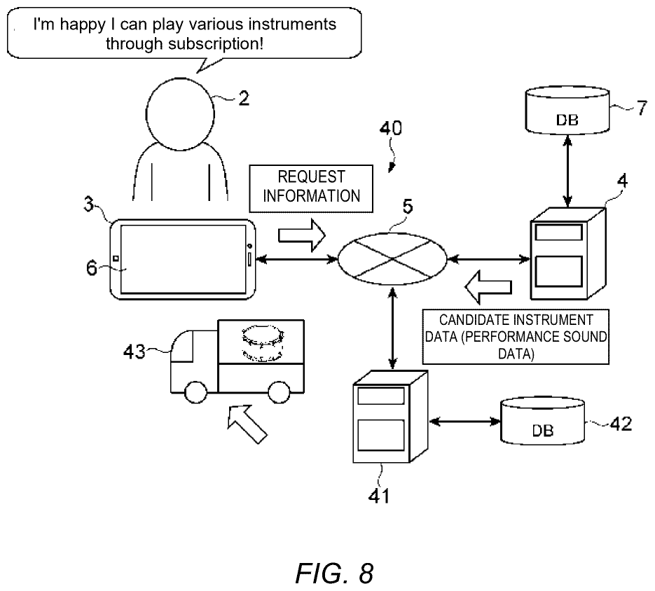

FIG. 7 is a schematic diagram showing a configuration example of an instrument selection support system according to a fourth embodiment of this disclosure.

In the present embodiment, one or more candidate instruments (candidate parts) can be test played before the user 2 selects a desired instrument to be provided.

In the present disclosure, a test play includes various forms of playing a candidate instrument (candidate part) before the user 2 selects a desired instrument to be provided (desired parts to be provided). Typically, the test play is when the user 2 actually plays a candidate instrument (candidate part) in real space (real world). However, the test play is not limited thereto. In the present disclosure, the test play also includes a case in which the user 2 wearing an HMD, etc., plays a candidate instrument (candidate part) in virtual space (virtual world).

For example, the user 2 wearing an HMD, etc., plays a virtual object of a snare drum that is a candidate instrument while holding actual sticks. At this time, performance sounds of the snare drum corresponding to the swinging of the arms and the striking of the sticks are output from the HMD, etc. The test play in the present disclosure also includes such a performance of a candidate instrument (candidate part) in virtual space.

In a performance of a desired instrument to be provided in virtual space, when the performance sound output from the HMD, etc., is a sound based on the performance sound produced when an actual snare drum is actually played, it is considered to be the test play according to this disclosure, and when the sound is a performance sound generated electronically (virtually), it is considered not to be the test play according to this disclosure. It is also possible to implement the present technique in accordance with such criteria.

In an instrument selection support system 37 shown in FIG. 7, a test play realization process execution unit (execution unit) 38 is configured as a functional block in the support server 4. This functional block is configured, for example, by a processor of the support server 4 executing a prescribed program, for example. Of course, dedicated hardware such as an integrated circuit (IC) can be used to realize the functional block.

The test play realization process execution unit 38 executes a test play realization process for realizing a test play of the one or more candidate instruments (candidate parts) by the user 2. The test play realization process includes any process for realizing delivery of one or more candidate instruments (candidate parts) to an address accessible to the user 2.

For example, assume that each of the users 2 is asked to create an account when using the present instrument selection support system 37. It thereby becomes possible to construct a user DB and to manage each piece of user information for each user ID.

In the present embodiment, a process is carried out relating to delivery of one or more candidate instruments (candidate parts) to where the user 2 resides or to a musical instrument store that is in an area accessible to the user 2, for the user information. For example, it is possible to realize a process for delivering one or more candidate instruments (candidate parts) to the home of the user 2, a school that the user 2 attends, a music class that the user 2 attends, a musical instrument store that is near the home of the user 2, etc.

The delivery of one or more candidate instruments (candidate parts) is not limited to delivering all of the candidate instruments (candidate parts), but also includes delivering at least one of the candidate instruments (candidate parts).

For example, the user 2 inputs an operation indicating that the user 2 wishes to test play one or more candidate instruments (candidate parts) in an application for using the present instrument selection support system 37. At this time, the user 2 can input the delivery destination for the one or more candidate instruments (candidate parts).

Information on stores that can be accessed by the user 2 and in which one or more candidate instruments (candidate parts) can be test played can be output as the test play realization process. For example, one or more musical instrument stores that are close to the home of the user 2, a school that the user 2 attends, or a music class that the user 2 attends and in which one or more candidate instruments (candidate parts) can be test played can be searched for and notified to the user 2.

For example, the test play realization process includes a process for delivering one or more candidate instruments (candidate parts) to a musical instrument store (authorized dealer, etc.) that is operated by a company that constructs the present instrument selection support system 37, or to a musical instrument store that is affiliated with the company that constructs the present instrument selection support system 37. In addition, the test play realization process includes a process for outputting information on a musical instrument store that is operated by a company that constructs the present instrument selection support system 37, or a musical instrument store that is affiliated with the company that constructs the present instrument selection support system 37, and in which it is possible to test play one or more candidate instruments (candidate parts).

Another example of the test play realization process is a process for realizing a test play of one or more candidate instruments (candidate parts) in virtual space. In this case, the test play realization process includes various processes by which a virtual space is provided to the user 2 wearing an HMD, etc.

For example, it is possible to have a stock of musical instruments for test playing for the user 2 to test play with, and deliver the musical instruments to a store, etc., as appropriate, for test playing candidate instruments (candidate parts). In addition, it can be configured such that the user 2 can select between delivery of one or more candidate instruments (candidate parts) and output of information on stores where one or more candidate instruments (candidate parts) can be test played.

In addition, in the present embodiment, the user 2 can input, into the user-side terminal 3, impression after test playing one or more candidate instruments (candidate parts). Then, the support server 4 can acquire the impression information (hereinafter referred to as test play impression information) of the user 2 who has test played one or more candidate instruments (candidate parts).

In the present embodiment, the impression information input reception unit 34 configured in the user-side terminal 3 receives input of the test play impression information from the user 2. For example, an input screen (GUI) for inputting the test play impression information is displayed in an application for using the present instrument selection support system 37. Then, the test play impression information is input via the input screen.

The specific format for inputting the test play impression information is not limited, and any format can be employed, such as text input, voice input, and questionnaire input (input of information by a questionnaire). In addition, the method, GUI, etc., by which the user 2 inputs the actual performance impression information is not limited, any can be freely designed.

For example, the test play impression information of when a snare drum listed as one or more candidate instruments is test played can be input for each evaluation item for the snare sound described with reference to FIG. 3, etc. For example, when the user thinks “I want a little more attack!”, the test play impression information is input indicating that it is better for the evaluation item of “attack” to have a higher numerical value. Of course, various other forms can be adopted for inputting the test play impression information.

In addition, performance sound data of when one or more candidate instruments (candidate parts) are test played or video of the performance can be input as the test play impression information.

The impression information acquisition unit 35 of the support server 4 receives the test play impression information input to the user-side terminal 3. In addition, the impression information acquisition unit 35 can further generate test play impression information based on the test play impression information received from the user-side terminal 3.

In the present embodiment, the impression information input reception unit 34 of the user-side terminal 3 and the impression information acquisition unit 35 of the support server 4 realize a test play impression information acquisition unit according to this disclosure which acquires the user's test play impression information when test playing one or more candidate instruments.

In addition, each of the user-side terminal 3 and the support server 4 constituting the instrument selection support system 37 functions as one embodiment of an information processing device equipped with the test play impression information acquisition unit according to this disclosure.

The test play impression information can be used for various purposes. For example, in the present embodiment, one or more candidate instruments (candidate parts) to be proposed to the user 2 are updated based on the acquired test play impression information. For example, it is also possible to process the test play impression information in the same manner as further request information for the reference instrument described above. For example, when the test play impression information indicating “I want a little more attack” is acquired, a snare drum with a high evaluation value for “attack” is presented as a new candidate instrument. This can be achieved using the same algorithm as the one used for acquiring further request information indicating a desire for more “attack” with respect to the reference instrument. Of course, a different algorithm can be used as well.

In addition, the usage of the actual performance impression information described above can also be applied to the usage of the test play impression information. For example, reference information (for example, evaluation criteria for each evaluation item) serving as a reference for selecting one or more candidate instruments can be updated based on the test play impression information. In addition, the development department of a company that manufactures musical instruments could use the test play impression information when developing a new product.

By making it possible to test play one or more candidate instruments (candidate parts), it becomes possible to further improve the satisfaction of the user 2.

### Fifth Embodiment

FIG. 8 is a schematic diagram showing a configuration example of an instrument selection support system according to a fifth embodiment of this disclosure.

An instrument selection support system 40 according to the present embodiment is configured as a system that provides musical instruments to the user 2 on a subscription basis. In other words, it is possible to construct the instrument selection support system 40 according to this disclosure within a subscription system that provides musical instruments to the user 2 on a subscription basis.

The subscription system refers to a system of sales in which the user 2 can freely consume a prescribed range of products during a given period (generally, a period of one day or more) for a fixed price, rather than each time paying a fee to purchase a product. Generally, a subscription system can also be considered as a system in which the user 2 rents the right to use an item instead of purchasing the item, and paying a fee in accordance with the period of use.

In the example shown in FIG. 8, the instrument selection support system 40 includes a subscription management server 41. The subscription management server 41 is connected to the user-side terminal 3 and the support server 4 so as to communicate with each other via the network 5.

In addition, in the present embodiment, a DB 42 that can be accessed by the subscription management server 41 is constructed. The DB 42 stores user information of one or more users 2 who use the present instrument selection support system 40, i.e., the present subscription system. For example, the DB 42 stores musical instrument purchase history and personal information of each user 2.

The subscription management server 41 functions as a subscription management unit and executes various processes relating to the provision of musical instruments using a subscription system. For example, the subscription management server 41 executes various processes such as payment management for the user 2 to purchase musical instruments, delivery management for delivering musical instruments to the user 2 via a delivery vehicle 43, or the like, management of use periods for musical instruments purchased by the user 2, management of receipt of musical instruments returned by the user 2, and maintenance management of musical instruments.

Provision of musical instruments on a subscription basis can be realized by using well-known techniques, for example. In addition, any other technique can be adopted in order to realize the provision of musical instruments on a subscription basis.

The support server 4 shown in FIG. 8 and the subscription management server 41 can be integrally configured. In addition, the DB 7 and the DB 42 can be integrally constructed.

For example, the user 2 downloads, onto the user-side terminal 3, an application for using the subscription system. For example, the user 2 inputs information such as an ID and password to create an account for using the subscription system.

The user 2 starts the application, and uses an instrument selection support service according to this disclosure to select a desired instrument to be provided (desired parts to be provided) that best suits the user 2, as described in the first to the fourth embodiments. Then, the user 2 purchases the desired instrument to be provided (desired parts to be provided) that the user 2 selected on a subscription basis. Of course, the fee structure, terms of use, etc., of the subscription can be freely set.

For example, many musical instruments such as snare drums are expensive, and it is difficult to repeatedly purchase new instruments. In addition, when there are many parts that constitute a musical instrument, it is difficult to find a combination of parts that best suits the user.

By constructing a subscription system as in the present embodiment, it becomes possible to easily try various musical instruments (parts), which is thought to be advantageous in finding a musical instrument (part) that is a perfect match for the user. In addition, it is thought that more pieces of the actual performance impression information and the test play impression information of the user 2 can be collected, which is advantageous from the perspectives of updating reference information (such as evaluation criteria for each evaluation item), realizing high-quality personalization, using feedback from the user 2 in product development, and the like.

### Other Embodiments

This disclosure is not limited to the embodiments described above, and various other embodiments can be realized.

An interactive process (response) can be carried out for the user 2 when presenting (displaying, outputting as sound, etc.) each piece of information to the user 2, and when acquiring each piece of information in accordance with an operation by the user 2, as described in the present disclosure.

For example, when receiving an input of request information via a questionnaire in step ST101 shown in FIG. 2, a portion of the content of the questionnaire can be dynamically changed in accordance with the answers of the user 2 to questionnaire items, and presented to the user 2. As a result, it is possible to present more detailed questionnaire items that are in line with the request of the user 2, making it possible to acquire more detailed request information.

In addition, in steps ST105 and ST106 of FIG. 2, when presenting one or more candidate instruments together with performance sound data, it can be configured so that it is possible to input questions regarding the candidate instruments or to input further request information. When there is an input of request information, the process can return to the request information transmission step in step ST102, and a new candidate instrument can be selected in steps ST103 and ST104. As a result, it becomes possible to more accurately accommodate the request of the user 2, thereby improving the satisfaction of the user 2. In addition, each of the steps shown in FIG. 2 can be executed in conjunction with each other as appropriate.

Performance skill information relating to the skill with which the user 2 plays a musical instrument (performance skill) can be referenced when the candidate instrument selection unit 12 of the support server 4 selects a candidate instrument (candidate part). That is, the candidate instrument selection unit 12 can select one or more candidate instruments (candidate parts) based on the performance skill information.

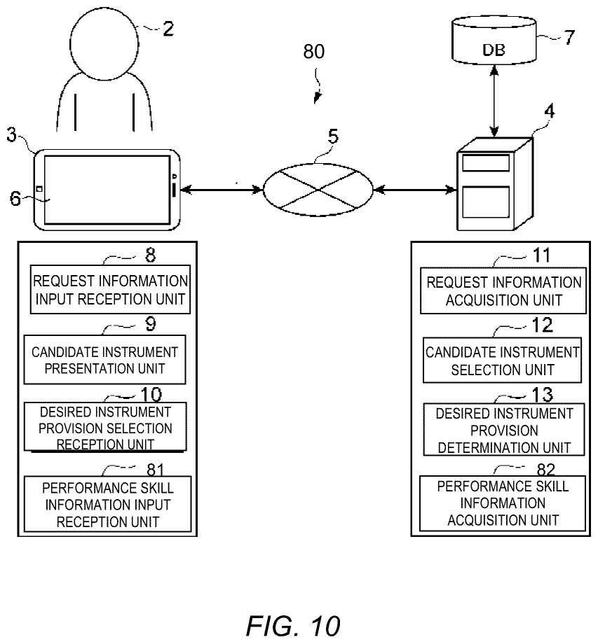

In order to obtain the skill information of each of the users 2, as shown in FIG. 10, a performance skill information acquisition unit is constructed as a functional block in the instrument selection support system 80. FIG. 10 is a schematic diagram showing a configuration example of the instrument selection support system according to one of the other embodiments. For example, a performance skill information input reception unit 81 is configured in the user-side terminal 3, and a performance skill information acquisition unit 82 is configured in the support server 4. These functional blocks are configured, for example, by a processor of each device executing a prescribed program. Of course, dedicated hardware such as an integrated circuit (IC) can be used to realize the functional blocks.

The performance skill information includes any information with which the performance skill of the user 2 can be determined as well as any information indicating the performance skill of the user 2. For example, video in which the user 2 is playing a musical instrument and performance sound data of when the user 2 played a musical instrument are examples of performance skill information.

For example, the performance skill information acquisition unit 82 of the support server 4 analyzes a performance video of the user 2 (including performance sound data) and determines the performance skill of the user 2. The determination result is included in the performance skill information. Performance skill can also be characteristics of a performance, and does not necessarily need to be categorized in terms of how well the user can play.

In addition, the user 2 can be asked to input a video in which the user 2 plays a device (for example, a practice pad in the case of a snare drum) for measuring performance skill, and the video can be analyzed to acquire the performance skill information. In addition, a device for measuring the performance skill can be delivered to the user 2 so that the performance skill can be measured.

For example, the skill (characteristics) relating to playing the snare drum is determined based on a video in which the user 2 plays the snare drum. For example, the skill (characteristics) of the user 2 is determined for each evaluation item relating to the snare sound, such as “brightness,” “volume,” “sustain,” “attack,” “response,” “thickness,” and “delicateness” described with reference to FIG. 3, etc.

For example, assume that it is determined from a performance video of the user 2 that the user 2 usually uses large strokes and plays loudly. In this case, performance skill information indicating that the user can usually achieve high numerical values for items such as “brightness,” “volume,” and “attack” is acquired. In addition, assume that it is determined from a video, in which the user plays the snare drum with extremely fine movements, that the user usually plays in a delicate manner. In this case, performance skill information indicating that the user can usually achieve high numerical values for items such as “delicateness” is acquired.

The acquired performance skill information is stored as user information of each user.

For example, assume that the user 2 who can usually achieve a high numerical value for “volume” inputs request information for a “snare drum with suppressed volume.” In this case, since the user 2 usually plays loud, a snare drum in which the evaluation item of “volume” is sufficiently suppressed (for example, “volume=1”) is proposed as a candidate instrument.

In addition, assume that the user 2 who can usually achieve a high numerical value for “delicateness” inputs request information for a “snare drum with a large attack.” In this case, since the user 2 usually plays delicately with a slightly weak attack, a snare drum in which the evaluation item of “attack” is sufficiently high (for example, “attack=5”) is proposed as a candidate instrument.

In this manner, candidate instruments are proposed in accordance with the skill (characteristics) of the user's performance. As a result, it becomes possible to propose, as a candidate instrument, a musical instrument that the user 2 desires and that is a perfect fit for the user 2, thereby improving the satisfaction of the user 2.

In the present instrument selection support system, there can be cases in which performance sound data of a candidate instrument cannot be prepared. In this case, information indicating that performance sound data cannot be prepared can be notified to the user 2. In addition, performance sound data that can be used as reference can be presented.

Parts constituting the musical instrument, such as “top hoop,” “bottom hoop,” “tension rods,” and “lugs” can be newly created using a 3D printer, for example. Then, the newly created parts can be proposed as candidate parts. That is, it is possible to use the present instrument selection support system to achieve custom-made musical instruments (parts) based on request information.

A drum instrument and parts that constitute the drum instrument are described as examples of a musical instrument above. Of course, without being limited to the above, the present technique can be applied to acoustic drums, electronic drums, various string instruments such as acoustic guitars, electric guitars, pianos, and violins, wind instruments, percussion instruments, keyboard instruments, electric instruments, Japanese instruments, and ethnic instruments, and each of the parts that constitute these instruments.

In the embodiment described above, an example is shown in which an application (application program) for using the present instrument selection support system is downloaded. That is, an example was shown in which a native application is used in order to use the present instrument selection support system. Not limited thereto, it is also possible to employ a configuration in which the instrument selection support system is used on a web page displayed in a web browser via a web application. In this case, the trouble of installing an application can be omitted and it becomes possible to avoid problems such as insufficient storage space on the terminal.

FIG. 9 is a block diagram showing an example of a hardware configuration of a computer 60 that can be used as the user-side terminal 3, the support server 4, and the subscription management server 41. The user-side terminal 3 can be further provided with an imaging function such as a camera.

The computer 60 includes a CPU 61, ROM 62, RAM 64, an input/output interface 65, and a bus 64 that connects the foregoing elements to each other. A display unit (display) 66, an input unit (user operable input) 67, a storage unit (memory, computer memory) 68, a communication unit 69, a drive unit (driver) 70, and the like are connected to the input/output interface 65. The CPU 61 is one example of the one or more processors and is included in an electronic controller of each of the user-side terminal 3 and the support server 4. Here, the term “electronic controller” as used herein refers to hardware, and does not include a human. The electronic controller can be configured to includes, instead of the CPU 61 or in addition to the CPU 61, a GPU, and a DSP, and the like.

The display unit 66 is a display device that uses liquid crystal, electroluminescence, etc. The input unit 67 is, for example, a keyboard, a pointing device, a touch panel, or another operation device. If the input unit 67 includes a touch panel, the touch panel can be integrated with the display unit 66.

The storage unit 68 is a non-volatile storage device, such as a HDD, flash memory, or other solid-state memory. The drive unit 70 is a device that can drive a removable recording medium 71, such as an optical recording medium or a magnetic recording tape.

The communication unit 69 is a modem, a router, or another communication device for communicating with other devices that can be connected to a LAN, a WAN, or the like. The communication unit 69 can communicate by wire or wirelessly. The communication unit 69 is often used separately from the computer 60.

Information processing by the computer 60 having the hardware configuration described above is realized by the cooperation between software stored in the storage unit 68, the ROM 62, or the like, and a hardware resource such as the computer 60. Specifically, a program constituting the software stored in the ROM 62 is loaded into the RAM 63 and executed, thereby realizing the information processing method according to this disclosure.

The program is installed onto the computer 60 via the recording medium 71, for example. Alternatively, the program can be installed onto the computer 60 via a global network, etc. Any computer-readable, non-transitory storage medium can be used.

The information processing method (instrument selection support system) and program according to this disclosure can be executed as a result of cooperation between a plurality of computers connected so as to be communicable with each other via a network etc., thereby constructing the information processing system and information processing device according to this disclosure.

That is, the information processing method and program according to this disclosure can be executed, not only by a computer system including a single computer, but also by a computer system in which a plurality of computers operate in conjunction with each other.

In the present disclosure, a system means a collection of a plurality of constituent elements (devices, modules (components) etc), regardless of whether all the constituent elements are within the same housing. Accordingly, a plurality of devices housed in different housings and connected to each other via a network, and one device in which a plurality of modules are housed in one housing, are both systems.

Execution of the information processing method and program according to this disclosure realized by a computer system includes both a case in which the acquisition of the request information, the selection of candidate instruments (candidate parts), the presentation of candidate instruments (candidate parts), the presentation of performance sound data, reception of the selection of a desired instrument to be provided (desired parts to be provided), the acquisition of actual performance impression information, the acquisition of test play impression information, the execution of the test play realization process, the acquisition of the performance skill information, and the like, are executed by a single computer, as well as a case in which different computers execute each of the processes. In addition, the execution of each process by a prescribed computer includes causing another computer to execute some or all of the process and acquiring the results thereof.

That is, the information processing method and program according to this disclosure can be applied to a cloud computing configuration in which one function is shared and jointly processed by a plurality of devices via a network.

The instrument selection support system, user-side terminal, support server, subscription system management server, various databases, configurations of GUIs for inputting various information such as request information and GUIS for proposing candidate instruments (candidate parts), acquisition of request information, and each of the process flows such as proposing candidate instruments (candidate parts), described with reference to the drawings, merely represent one embodiment and can be freely modified within the scope of the spirit of this disclosure. That is, any other configurations or algorithms can be employed for implementing this disclosure.

In the present disclosure, there can be cases in which words such as “substantially,” “almost,” and “approximately” are used, as appropriate, in order to facilitate understanding of the explanation. On the other hand, there is no clearly defined difference between using and not using words such as “substantially,” “almost,” and “approximately.”

That is, in the present disclosure, concepts defining the shape, size, positional relationship, status, etc., such as “center,” “central,” “uniform,” “equal,” “same,” “perpendicular,” “parallel,” “symmetrical,” “extend,” “axial,” “columnar,” “cylindrical,” “ring-shaped,” and “annular” are concepts that include “substantially center,” “substantially central,” “substantially uniform,” “substantially equal,” “substantially same,” “substantially perpendicular,” “substantially parallel,” “substantially symmetrical,” “substantially extend,” “substantially axial,” “substantially columnar,” “substantially cylindrical,” “substantially ring-shaped,” and “substantially annular.”

For example, the foregoing concepts also include states that fall within a prescribed range (e.g., a range of ±10%) based on references such as “perfectly center,” “perfectly central,” “perfectly uniform,” “perfectly equal,” “perfectly same,” “perfectly perpendicular,” “perfectly parallel,” “perfectly symmetrical,” “perfectly extend,” “perfectly axial,” “perfectly columnar,” “perfectly cylindrical,” “perfectly ring-shaped,” “perfectly annular,” etc.

Accordingly, even if words like “substantially,” “almost,” and “approximately” are not used, concepts that would be expressed with the addition of such terms as “substantially,” “almost,” “approximately,” etc. can be included. Conversely, concepts that would be expressed with the addition of such terms as “substantially,” “almost,” “approximately,” etc. do not necessarily exclude perfect states.

In the present disclosure, expressions using “than” such as “greater than A” and “less than A,” are expressions that comprehensively include both concepts that include cases of being equal to A and concepts that do not include cases of being equal to A. For example, “greater than A” is not limited to cases of excluding being equal to A, but rather includes “greater than or equal to A.” In addition, “less than A” is not limited to “less than A,” but rather includes “less than or equal to A.”

When implementing the present technique, specific settings and other parameters can be appropriately adopted from concepts included in “greater than A” and “less than A” so that the effects described above are achieved.

Of the characteristic features according to this disclosure described above, two or more characteristic features can be combined. That is, the various characteristic features described above in the embodiments can be freely combined without distinction between the embodiments. In addition, the various effects described above are merely examples, and are not limiting, and other effects can be exhibited.

What is claimed is:

1. An information processing system comprising:
at least one processor configured to execute
a request information acquisition unit configured to acquire request information of a user relating to a musical instrument,
a proposal unit configured to select one or more candidate instruments corresponding to the request information, and propose, to the user, the one or more candidate instruments that have been selected, together with performance sound data of each of the one or more candidate instruments, and
a reception unit configured to, from among the one or more candidate instruments, receive a selection of a desired instrument to be provided, the selection being input by the user.

2. The information processing system according to claim 1, wherein
the musical instrument includes parts that constitute the musical instrument,
the one or more candidate instruments include one or more candidate parts,
the proposal unit is configured to propose, to the user, the one or more candidate parts together with performance sound data of the musical instrument each of which is formed using each of the one or more candidate parts, and
the reception unit is configured to receive a selection of a desired part to be provided from among the one or more candidate parts.

3. The information processing system according to claim 1, wherein
the proposal unit is configured to receive a selection of a reference instrument that serves as a reference for selecting the desired instrument to be provided from among the one or more candidate instruments, the selection of the reference instrument is input by the user,
the request information acquisition unit is configured to acquire the request information including further request of the user regarding the reference instrument, and
the proposal unit is configured to change one or more parts constituting the reference instrument based on the further request regarding the reference instrument, and propose to the user the one or more parts that have been changed.

4. The information processing system according to claim 1, further comprising
an actual performance impression information acquisition unit configured to acquire actual performance impression information of the user after the desired instrument to be provided is actually played by the user, wherein
the proposal unit is configured to update reference information that serves as a reference for selecting the one or more candidate instruments based on the actual performance impression information.

5. The information processing system according to claim 1, further comprising
an execution unit configured to execute a test play realization process for realizing a test play of the one or more candidate instruments by the user.

6. The information processing system according to claim 5, wherein
the test play realization process includes a process for at least one or both of realizing delivery of the one or more candidate instruments to an address that is accessible by the user or realizing output of information on a store where the user is accessible to test play the one or more candidate instruments.

7. The information processing system according to claim 1, further comprising
a test play impression information acquisition unit configured to acquire test play impression information of the user after the one or more candidate instruments are test played by the user, wherein
the proposal unit is configured to update the one or more candidate instruments to be proposed to the user based on the test play impression information.

8. The information processing system according to claim 1, wherein
the request information includes a request relating to characteristics of performance sound of the musical instrument.

9. The information processing device according to claim 1, wherein
the request information acquisition unit is configured to output a questionnaire relating to the musical instrument, and acquire, as the response information, information on an answer to the questionnaire.

10. The information processing system according to claim 1, wherein
the proposal unit is configured to set a recommendation level for the user for each of the one or more candidate instruments, and propose the one or more candidate instruments with the recommendation level reflected.

11. The information processing system according to claim 1, further comprising
a performance skill information acquisition unit configured to acquire performance skill information relating to a skill of the user in playing the musical instrument, wherein
the proposal unit is configured to select the one or more candidate instruments based on the performance skill information.

12. The information processing system according to claim 1, wherein
the musical instrument includes a drum instrument and parts constituting the drum instrument.

13. The information processing system according to claim 1, wherein
the system is configured to provide the musical instrument to the user on a subscription basis.

14. An information processing method executed by a computer system, the method comprising:
acquiring request information of a user relating to a musical instrument;
selecting one or more candidate instruments corresponding to the request information, and proposing, to the user, the one or more candidate instruments that have been selected, together with performance sound data of each of the one or more candidate instruments; and
receiving a selection of a desired instrument to be provided from among the one or more candidate instruments, the selection being input by the user.

15. A non-transitory computer-readable medium storing a program that causes a computer system to execute a process comprising:
acquiring request information of a user relating to a musical instrument;
selecting one or more candidate instruments corresponding to the request information, and proposing, to the user, the one or more candidate instruments that have been selected, together with performance sound data of each of the one or more candidate instruments; and
receiving a selection of a desired instrument to be provided from among the one or more candidate instruments, the selection being input by the user.

16. An information processing device comprising:
at least one processor configured to execute
a request information acquisition unit configured to acquire request information of a user relating to a musical instrument,
a proposal unit configured to select one or more candidate instruments corresponding to the request information, and propose, to the user, the one or more candidate instruments that have been selected, together with performance sound data of each of the one or more candidate instruments, and
a reception unit configured to receive a selection of a desired instrument to be provided from among the one or more candidate instruments, the selection being input by the user.
